(19) United States
(12) Patent Application Publication
(10) Pub. No.: US 2002/0003041 A1
(43) Pub. Date: Jan. 10, 2002

(54) Flexible spiral tube for fire extinguishing sprinkler systems

(76) Inventor: Jin Lim Choi, Kyungki-do (KR)

Correspondence Address: SHLESINGER, ARKWRIGHT & GARVEY LLP, 3000 South Eads Street, Arlington, VA, 22202, US

(21) Appl. No.: 09/768,336

(22) Filed: Jan. 25, 2001

(30) Foreign Application Priority Data
Jun. 1, 2000 (KR) 2000/30108

(51) Int. Cl. A62C 35/00

(52) U.S. Cl. 169/5; 239/602

(57) ABSTRACT

Disclosed herein is a flexible spiral tube for fire extinguishing systems. This invention provides a flexible spiral tube, which is not only highly flexible but also resistant to elongation, so that the tube is not easily ruptured by bending to allow the fire extinguishing sprinkler system to be easily installed in the interior of a ceiling, and is not excessively elongated by the high pressure of a fire extinguishing fluid to prevent the sprinkler head of the sprinkler system from being undesirably removed from the ceiling. The flexible spiral tube is preferably dimensioned to have an outer diameter ranging from 26.0 to 27.5 mm, a thickness ranging from 0.3 to 0.4 mm, a pitch ranging from 5.9 to 6.5 mm, the width of its groove ranging from 2.4 to 2.5 mm, and the height of its ridge ranging from 2.65 to 2.75 mm.

### BACKGROUND OF THE INVENTION

1. Field of the Invention

The present invention relates generally to a flexible spiral tube for fire extinguishing sprinkler systems, and more particularly to a flexible spiral tube for fire extinguishing sprinkler systems, which is situated in the ceiling of a building and connects a sprinkler head to a main conduit for supplying a fire extinguishing fluid, such as water or fire extinguishing gas.

2. Description of the Prior Art

A fire extinguishing sprinkler system is installed in the interior of the ceiling of a building. As illustrated in FIG. 1, a general fire extinguishing sprinkler system includes a support rod 3 that is also supported by clamping devices 1 on ceiling bars 2 attached to a ceiling panel “A”. A reducer 4 provided with a sprinkler head 5 at its lower end is attached to the support rod 3 by a clamping device 6. A flexible spiral tube 7 is connected to the upper end of the reducer 4 by means of a clamping nut 8. A main supply pipe (not shown) for supplying a fire extinguishing fluid is connected to the flexible spiral tube 7 through a nipple 9.

Such a flexible spiral tube should be situated in order not to interfere with heating and cooling ducts, ceiling beams, electrical and communications conduits and electric lights. Accordingly, the flexible spiral tube 7 should have sufficient flexibility not to be ruptured despite its being bent several tens of times, should not be excessively elongated so as to prevent the sprinkler head 5 from being removed from the ceiling plate “A” due to its elongation when the extinguishing fluid having a high pressure greater than 17.5 kg/cm² is supplied through it, and should have a small resistance against the fire extinguishing fluid when the fire extinguishing fluid is supplied through it. However, the flexible spiral tube has a correlation in which if it has great flexibility, it is easily elongated and accordingly is excessively elongated by the application of high pressure, whereas if it is not elongated much, it has inferior flexibility and accordingly is easily ruptured by bending, thus causing the fire extinguishing fluid to leak.

As a result, the flexible spiral tube for fire extinguishing sprinkler systems should be not only highly flexible but also resistant to elongation.

In the meantime, many countries regulate the standard of a flexible spiral tube in terms of a bending test, an elongation test and a pressure test.

When a conventional, general spiral tube or a conventional, general corrugated tube is utilized for fire extinguishing systems, there occur shortcomings in which the sprinkler head is undesirably removed from a ceiling plate due to its excessive elongation when a high pressure is applied for the extinguishment of fire and a fire extinguishing fluid leaks due to the rupture of the tube when the tube is bent several times during the installation of a fire extinguishing system.

Meanwhile, in order to overcome the shortcomings of being easily ruptured and excessively elongated, there has been proposed a flexible tube in which a tube is surrounded by a protective net woven out of stainless steel wires. However, this flexible tube is excessively expensive, so that this flexible tube with a stainless wire net is difficult to utilize widely.

### SUMMARY OF THE INVENTION

Accordingly, the present invention has been made keeping in mind the above problems occurring in the prior art, and an object of the present invention is to provide a flexible spiral tube for fire extinguishing sprinkler systems, which is not only highly flexible but also resistant to elongation so that the tube is not easily ruptured by bending thus allowing the fire extinguishing sprinkler system to be easily installed in the interior of a ceiling, and is not excessively elongated by the high pressure of a fire extinguishing fluid thus preventing the sprinkler head of the fire extinguishing sprinkler from being undesirably removed from the ceiling.

In order to accomplish the above object, the present invention provides a flexible spiral tube, which is used for fire extinguishing sprinkler systems, the flexible spiral tube being dimensioned to have an outer diameter ranging from 26.0 to 27.5 mm, a thickness ranging from 0.3 to 0.4 mm, a pitch ranging from 5.9 to 6.5 mm, the width of its groove ranging from 2.4 to 2.5 mm, and the height of its ridge ranging from 2.65 to 2.75 mm.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a general fire extinguishing sprinkler system installed in the interior of the ceiling of a building;

FIG. 2 is a perspective view of a flexible spiral tube in accordance with the present invention; and

FIG. 3 is a side view showing a state in which a bending test is performed.

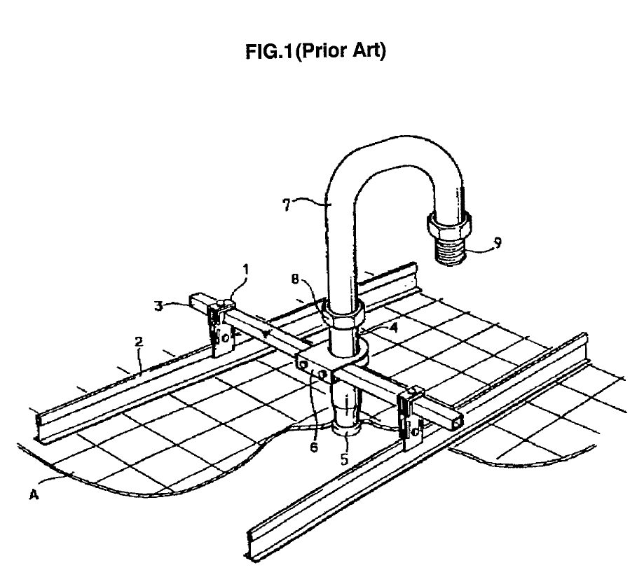

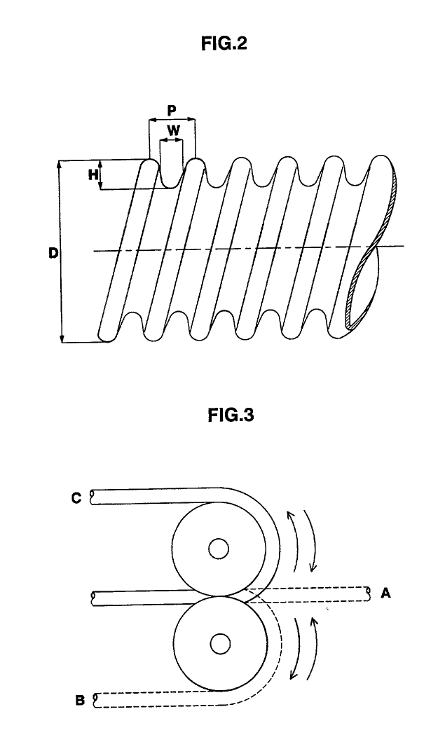

### DESCRIPTION OF THE PREFERRED EMBODIMENTS

Reference now should be made to the drawings, in which the same reference numerals are used throughout the different drawings to designate the same or similar components.

In the following examples, elongation ratios E and the endurable numbers of times of bending R were measured using specimen spiral tubes, which were made of stainless steel STS 316L (UNS-S31603) and had dimensions specified in the following examples, respectively. The elongation ratios E were measured after a water pressure of 17.5 kg/cm² had been applied through one end of each tube for three minutes while the other end was stopped up. Each endurable number of times of bending R was measured by counting the number of times of bending till each tube was ruptured to allow water to leak while the tube was repeatedly bent in first cycle of A→B→A and second cycle of A→C→A as shown in FIG. 3 and a water pressure of 1 kg/cm² was applied to the tube. In such a case, one cycle was counted as one time of bending.

The stainless steel STS 316L is stainless steel containing Carbon at 0.03% or less, Si at 0.5 to 0.75%, P at 0.045% or less, S at 0.030% or less, Ni at 12.00 to 15.00%, Cr at 16.00 to 18.00% and Mo at 2.00 to 3.00%.

### EXAMPLE 1

A specimen spiral tube was manufactured to have an outer diameter D of 26 mm, a thickness T of 0.3 mm, a pitch P of 6.50 mm, the width of a groove W of 2.40 mm, the height of a ridge H of 2.65 mm, and a length L₁ of 835 mm. The elongation ratio E and the endurable number of times of bending R of this specimen spiral tube were measured. As a result of the measurements, there were obtained an elongation ratio E of 0.38% and the endurable number of times of bending R of 15.

### EXAMPLE 2

For a specimen spiral tube having an outer diameter D of 26.5 mm, a thickness T of 0.3 mm, a pitch P of 6.33 mm, the width of a groove W of 2.45 mm, the height of a ridge H of 2.70 mm, and a length L₁ of 847.5 mm, there were obtained an elongation ratio E of 0.41% and the endurable number of times of bending R of 16.

### EXAMPLE 3

For a specimen spiral tube having an outer diameter D of 27 mm, a thickness T of 0.3 mm, a pitch P of 6.25 mm, the width of a groove W of 2.50 mm, the height of a ridge H of 2.73 mm, and a length L₁ of 832.5 mm, there were obtained an elongation ratio E of 0.48% and the endurable number of times of bending R of 17.

### EXAMPLE 4

For a specimen spiral tube having an outer diameter D of 27.2 mm, a thickness T of 0.3 mm, a pitch P of 6.10 mm, the width of a groove W of 2.55 mm, the height of a ridge H of 2.74 mm, and a length L₁ of 840 mm, there were obtained an elongation ratio E of 0.54% and the endurable number of times of bending R of 18.

### EXAMPLE 5

For a specimen spiral tube having an outer diameter D of 27.5 mm, a thickness T of 0.4 mm, a pitch P of 5.90 mm, the width of a groove W of 2.60 mm, the height of a ridge H of 2.75 mm, and a length L₁ of 845 mm, there were obtained an elongation ratio E of 0.40% and the endurable number of times of bending R of 17.

The following table 1 summarizes the conditions and results of the measurements of the above-described examples.

TABLE 1

| | Example | Example | Example | Example | Example |
|---|---|---|---|---|---|
| | 1 | 2 | 3 | 4 | 5 |
| Outer | 26.0 | 26.5 | 27.0 | 27.2 | 27.5 |
| Diameter D | | | | | |
| (mm) | | | | | |
| Thickness T | 0.3 | 0.3 | 0.3 | 0.3 | 0.4 |
| (mm) | | | | | |
| Pitch P | 6.50 | 6.33 | 6.25 | 6.10 | 5.90 |
| (mm) | | | | | |
| Width of | 2.40 | 2.45 | 2.50 | 2.55 | 2.60 |
| groove W | | | | | |
| (mm) | | | | | |
| Height of | 2.65 | 2.70 | 2.73 | 2.74 | 2.75 |
| ridge H | | | | | |
| (mm) | | | | | |
| Length prior | 835 | 847.5 | 832.5 | 840 | 845 |
| to bending | | | | | |
| L₁ (mm) | | | | | |
| Length after | 838.2 | 851 | 836.5 | 844.5 | 849.7 |
| bending L₂ | | | | | |
| (mm) | | | | | |
| Elongated | 3.2 | 3.5 | 4.0 | 4.5 | 4.7 |
| length L₃ | | | | | |
| (L₂ − L₁) | | | | | |
| (mm) | | | | | |
| Elongating | 0.38 | 0.41 | 0.48 | 0.54 | 0.40 |
| ratio E (L₃/ | | | | | |
| L₁ × 100) | | | | | |
| (%) | | | | | |
| Endurable | 15 | 16 | 17 | 18 | 17 |
| number of | | | | | |
| times of | | | | | |
| bending R | | | | | |

As apparent from table 1, as the pitch P was increased, the elongation ratio E was reduced but the endurable number of times of bending R was increased, whereas as the width of a groove W was increased, the elongation ratio E was increased and the endurable number of times of bending R was increased. In the flexible spiral tube of the present invention, an elongation ratio E measured after a hydraulic pressure of 17.5 kg/cm2 had been applied to the flexible spiral tube for 3 minutes was 0.54% or less, whereas the endurable number of times of bending measured while a hydraulic pressure of 1 kg/cm² was applied to the flexible spiral tube was 15 or more. Accordingly, the flexible spiral tube of the present invention is hardly elongated while the high pressure of a fire extinguishing fluid is applied to the interior of the flexible spiral tube during the operation of the fire extinguishing sprinkler system, whereas leakage does not occur in the flexible spiral tube when the flexible spiral tube is bent a plurality of times. As a result, the flexible spiral tube of the present invention does not cause any hindrance to use.

In the following comparative examples which were made of the same material as of the above-described examples, elongation ratios E and the endurable numbers of times of bending R were measured under the same condition for measuring those of the specimen spiral tubes.

### COMPARATIVE EXAMPLE 1

For a specimen spiral tube having an outer diameter D of 26.8 mm, a thickness T of 0.3 mm, a pitch P of 4.0 mm, the width of a groove W of 1.0 mm, the height of a ridge H of 2.45 mm, and a length L₁ of 852 mm, there were obtained an elongation ratio E of 4.69% and the endurable number of times of bending R of 4.

### COMPARATIVE EXAMPLE 2

For a specimen spiral tube having an outer diameter D of 26.8 mm, a thickness T of 0.3 mm, a pitch P of 4.5 mm, the width of a groove W of 1.5 mm, the height of a ridge H of 2.50 mm, and a length L₁ of 854 mm, there were obtained an elongation ratio E of 3.16% and the endurable number of times of bending R of 5.

### COMPARATIVE EXAMPLE 3

For a specimen spiral tube having an outer diameter D of 26.8 mm, a thickness T of 0.3 mm, a pitch P of 5.0 mm, the width of a groove W of 2.0 mm, the height of a ridge H of 2.55 mm, and a length L₁ of 856 mm, there were obtained an elongation ratio E of 0.35% and the endurable number of times of bending R of 6.

### COMPARATIVE EXAMPLE 4

For a specimen spiral tube having an outer diameter D of 26.8 mm, a thickness T of 0.3 mm, a pitch P of 5.5 mm, the width of a groove W of 2.5 mm, the height of a ridge H of 2.60 mm, and a length L₁ of 847 mm, there were obtained an elongation ratio E of 0.47% and the endurable number of times of bending R of 10.

### COMPARATIVE EXAMPLE 5

For a specimen spiral tube having an outer diameter D of 26.8 mm, a thickness T of 0.3 mm, a pitch P of 6.8 mm, the width of a groove W of 2.8 mm, the height of a ridge H of 2.78 mm, and a length L₁ of 844 mm, there were obtained an elongation ratio E of 0.36% and the endurable number of times of bending R of 10.

The following table 2 summarizes the conditions and results of the measurements of the above-described comparative examples.

TABLE 2

| | Comp. | Comp. | Comp. | Comp. | Comp. |
|---|---|---|---|---|---|
| | Example | example | example | example | example |
| | 1 | 2 | 3 | 4 | 5 |
| Outer | 26.8 | 26.8 | 26.8 | 26.8 | 26.8 |
| Diameter D | | | | | |
| (mm) | | | | | |
| Thickness T | 0.3 | 0.3 | 0.3 | 0.3 | 0.3 |
| (mm) | | | | | |
| Pitch P | 4.0 | 4.5 | 5.0 | 5.5 | 6.8 |
| (mm) | | | | | |
| Width of | 1.0 | 1.5 | 2.0 | 2.5 | 2.8 |
| groove W | | | | | |
| (mm) | | | | | |
| Height of | 2.45 | 2.50 | 2.55 | 2.60 | 2.78 |
| ridge H | | | | | |
| (mm) | | | | | |
| Length prior | 852 | 854 | 856 | 847 | 844 |
| to bending | | | | | |
| L₁ (mm) | | | | | |
| Length after | 892 | 881 | 859 | 851 | 847 |
| bending L₂ | | | | | |
| (mm) | | | | | |
| Elongated | 40 | 27 | 3 | 4 | 3 |
| length L₃ | | | | | |
| (L₂ − L₁) | | | | | |
| (mm) | | | | | |
| Elongating | 4.69 | 3.16 | 0.35 | 0.47 | 0.36 |
| ratio E (L₃/ | | | | | |
| L_{1 × 100)} | | | | | |
| (%) | | | | | |
| Endurable | 4 | 5 | 6 | 10 | 10 |
| number of | | | | | |
| times of | | | | | |
| bending R | | | | | |

In the cases of comparative examples 1 and 2, since elongation ratios E are large and the endurable numbers of times of bending R are small, the flexible spiral tubes used in these comparative examples are easily elongated when the high pressure of a fire extinguishing fluid is applied to the flexible spiral tubes, and easily ruptured when a plurality of times of bending is performed, thus not being suitable for use as the flexible spiral tubes for a fire extinguishing sprinkler systems. In the cases of comparative examples 3, 4 and 5, since elongation ratios E are small and the endurable number of times of bending R are small, the flexible spiral tubes used in these comparative examples each have the shortcoming of easily being ruptured.

As described above, the present invention provides a flexible spiral tube in which its outer diameter, its thickness, its pitch, the width of groove and the height of ridge are effectively designed, so that it is not easily ruptured despite a plurality of times of bending and is not easily elongated despite the application of high pressure, thus being suitable for fire extinguishing sprinkler systems.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A flexible spiral tube, which is used for fire extinguishing sprinkler systems, said flexible spiral tube being dimensioned to have an outer diameter ranging from 26.0 to 27.5 mm, a thickness ranging from 0.3 to 0.4 mm, a pitch ranging from 5.9 to 6.5 mm, the width of its groove ranging from 2.4 to 2.5 mm, and the height of its ridge ranging from 2.65 to 2.75 mm.

2. The flexible spiral tube according to claim 1, wherein said outer diameter is 27.2 mm, said thickness is 0.3 mm, said pitch is 6.1 mm, and said width of the groove is 2.55 mm.

3. The flexible spiral tube according to claim 1 or 2, wherein said flexible spiral tube is made of stainless steel STS 316L (UNS-S31603).
